(19) United States
(12) Patent Application Publication
(10) Pub. No.: US 2007/0223939 A1
(43) Pub. Date: Sep. 27, 2007

(54) Optical transmitter

(75) Inventor: Hideo Arimoto, Kokubunji (JP)

Correspondence Address: Stanley P. Fisher;Reed Smith LLP, Suite 1400, 3110 Fairview Park Drive, Falls Church, VA, 22042-4503, US

(73) Assignee: Hitachi, Ltd.

(21) Appl. No.: 11/699,365

(22) Filed: Jan. 30, 2007

(30) Foreign Application Priority Data
Mar. 24, 2006 (JP) 2006-082129

(51) Int. Cl. H04B 10/04

(52) U.S. Cl. 398/198

(57) ABSTRACT

As a capacity of an output interface of an electronic circuit is increased, there results a significant increase in the number of channels of optical signals on a semiconductor LSI, converted from electrical signals. Since a semiconductor laser used as a means for generating the optical signal is inferior in reliability to the semiconductor LSI, a problem arises as the number of optical signals is increased in that the number of the semiconductor lasers needs be reduced. To solve the problem, for an optical transmitter, use is made of a structure wherein a continuous laser beam from a semiconductor laser is subjected to modulation in external optical modulators to thereby generate optical signals instead of a structure wherein electric current of a semiconductor laser as an optical signal source is directly modulated. After splitting the continuous laser beam from the semiconductor laser into laser beam components to be subjected to modulation by the external optical modulators, thereby generating the optical signals. If the continuous laser beam is split into for example, eight components, the number of the semiconductor lasers is reduced to ⅛, resulting in enhanced reliability of the optical transmitter.

### CLAIM OF PRIORITY

The present application claims priority from Japanese application JP 2006-082129 filed on Mar. 24, 2006, the content of which is hereby incorporated by reference into this application.

### FIELD OF THE INVENTION

The invention relates to an optical transmitter and in particular, to a technology concerning an ultra-small sized optical transmitter effective for converting an output from an electronic circuit into an optical signal for transmission for the purpose of increasing a capacity of an output interface of the electronic circuit, thereby reducing the number of lasers, and enhancing reliability.

### BACKGROUND OF THE INVENTION

As a result of a rapidly widening band of a communications infrastructure, and a quantum leap in information processing capacity of a computer, and so forth, taking place recently, there has been an increase in needs for an information processing circuit having an extremely fast information transmission path. With this in the background, transmission by means of an optical signal has been contemplated as one of means for breaking through the transmission speed limit of an electrical signal.

Now, it is assumed that a signal is taken out of a semiconductor LSI (Large Scale Integrated Circuit) 1 cm square to be then transmitted. If a capacity of signals taken out of a LSI chip in the case of transmission by means of an electrical signal according to the current technology is 10 Gbps per 1 ch, and a pitch of a transmission path is 100 μm, 10 Gbps×100 channels=1 Tbps will be the limit of the capacity. This capacity is insufficient to meet requirements for a future increase in capacity.

Meanwhile, in the case where an output is converted into an optical signal on the semiconductor LSI, and is transmitted by means of the optical signal, a capacity of the optical signals that can be taken out of the LSI chip will be 25.2 Tbps on the assumption that a capacity per 1 ch is 40 Gbps, a pitch of a transmission path (an optical waveguide) is 125 μm, and 8 wavelength multiplexing is adopted, thereby attaining a capacity 25 times as large as that in the case of the electrical signal.

### SUMMARY OF THE INVENTION

As described in the foregoing, in order to attain the capacity of 25.2 Tbps against an information processing circuit having a fast information transmission path, for example, 640 channels of optical signals are required. That is, as many as 640 units of lasers are required.

Now, high reliability is required of the semiconductor LSI, however, a semiconductor laser for generating the optical signal is generally inferior in reliability to the semiconductor LSI. Accordingly, for the semiconductor laser to secure reliability as high as that for the semiconductor LSI, there exists a problem that the number of the semiconductor lasers need be reduced as much as possible without reducing the number of optical signals.

It is therefore an object of the invention to provide a technology for implementing an information processing circuit having a fast information transmission path where the number of semiconductor lasers inferior in reliability to a semiconductor LSI is reduced to a minimum.

In JP-A No. 197837/1998, there has been disclosed a multi-channel optical modulator wherein the number of optical signals is increased with the number of semiconductor lasers kept constant. However, this invention relates to a bulk optical system, and does not disclose a structure concerning an optical system of an optical waveguide on a semiconductor substrate, related to a problem to be solved by the present invention.

To achieve the object of the invention, in accordance with one aspect of the invention, there is provided a optical transmitter comprising a first optical waveguide optically coupled to a semiconductor laser for causing a laser beam outputted from the semiconductor laser to be propagated, an optical splitter connected to the first optical waveguide, for splitting the laser beam into a plurality of laser beam components, second waveguides connected to a plurality of optical output terminals of the optical splitter, respectively, optical modulators optically coupled to the second waveguides, respectively, and an electronic circuit for feeding a control signal to the respective optical modulators, respective constituents being provided on a semiconductor substrate, wherein the laser beam components propagated through the respective optical modulators are modulated by the agency of the control signal.

Further, a structure wherein a continuous laser beam from a semiconductor laser is subjected to modulation by external optical modulators to thereby generate optical signals is adopted instead of a structure wherein electric current of a semiconductor laser as an optical signal source is directly modulated. After splitting the continuous laser beam from the semiconductor laser into laser beam components to be subjected to modulation by the external optical modulators, respectively, thereby generating the optical signals. If the continuous laser beam is split into for example, eight components, the number of the semiconductor lasers is reduced to ⅛, resulting in enhanced reliability. In this connection, the external optical modulators each are regarded higher in reliability than the semiconductor laser, so that there is no need for reducing the number of the external optical modulators.

With the invention, optical signals in large capacity can be drawn from a semiconductor LSI chip while keeping reliability of an optical transmitter as high as that for the semiconductor LSI.

### BRIEF DESCRIPTION OF THE DRAWINGS

FIG. 1 is a top view showing a first embodiment of an optical transmitter according to the invention;

FIG. 2 is a top view showing a second embodiment of an optical transmitter according to the invention;

FIG. 3 is a top view showing a third embodiment of an optical transmitter according to the invention; and

FIG. 4 is a view showing a process flow for fabricating the optical transmitter according to the invention by way of example.

### DETAILED DESCRIPTION OF THE PREFERRED EMBODIMENTS

Embodiments of an optical transmitter according to the invention are described hereinafter with reference to the accompanying drawings

### Embodiment 1

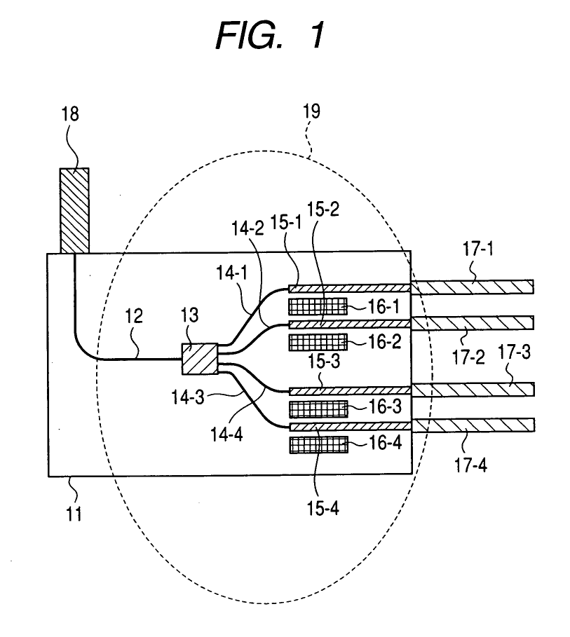

FIG. 1 shows a first embodiment of an optical transmitter according to the invention. The present embodiment shows the case where a laser beam is split into four laser beam components. Optical modulator drive circuits 16-1, 16-2, 16-3, 16-4, a laser beam input optical waveguide 12, a MMI (Multi Mode Interferometer) optical splitter 13, optical splitter output waveguides 14-1, 14-2, 14-3, 14-4, optical modulators 15-1, 15-2, 15-3, 15-4 are formed on a semiconductor substrate 11 made of InP. Further, a laser 18 is prepared and is optically coupled to the laser beam input optical waveguide 12. A continuous laser beam outputted from the laser 18 passes through the laser beam input optical waveguide 12 to be split into the four beam components by the MMI (Multi Mode Interferometer) optical splitter 13, and the four beam components are propagated through the optical splitter output waveguides 14-1, 14-2, 14-3, 14-4, respectively. The respective beam components are subjected to modulation by the optical modulators 15-1, 15-2, 15-3, 15-4, respectively, according to respective electrical signals from the optical modulator drive circuits 16-1, 16-2, 16-3, 16-4 before being outputted to optical fibers 17-1, 17-2, 17-3, 17-4, respectively. With the adoption of a structure described as above, the number of the lasers inferior in reliability is reduced from four units as in the past to one unit, so that the optical transmitter can be enhanced in reliability.

A method for fabricating the optical transmitter according to the present embodiment is described as follows. First, the optical modulator drive circuits 16-1, 16-2, 16-3, 16-4 are fabricated on the semiconductor substrate 11. The method for fabricating the same is in accordance with a normal method for fabricating a semiconductor LSI. Then, after protecting the optical modulator drive circuits 16-1, 16-2, 16-3, 16-4 with an insulating film, there are formed respective absorption layers of the optical modulators 15-1, 15-2, 15-3, 15-4, and respective core layers of the laser beam input optical waveguide 12, the MMI (Multi Mode Interferometer) optical splitter 13, and the optical splitter output waveguides 14-1, 14-2, 14-3, 14-4 through selective growth by use of the metalorganic vapor phase epitaxy method. Subsequently, the respective optical waveguides are formed by a normal technology for selective dry etching with the use of a mask in the shape of insulated stripes. A layout of the optical waveguides will be understood by taking a top view of FIG. 1 into consideration. Then, after planarization with polyimide, electrodes are formed on the optical modulator drive circuits 16-1, 16-2, 16-3, 16-4, and the optical modulators 15-1, 15-2, 15-3, 15-4, respectively. Further, the semiconductor laser is prepared, and is optically coupled to the laser beam input optical waveguide 12.

The optical transmitter fabricated as above was found to output the laser beam at a wavelength of 1551 nm, modulated at 40 Gbps by all four channels of the optical modulators 15-1, 15-2, 15-3, 15-4, thereby outputting excellent optical signals.

In the foregoing, there has been shown an example where the laser beam was split into the four laser beam components, however, the number of split beam components is not limited thereto, and may be a plurality not less than two. The laser beam is split by the MMI optical splitter 13, however, the laser beam may be split by a Y-branching waveguide instead. Further, as a typical embodiment of the present invention, there has been described a high-mesa ridge type laser structure using a crystalline material on the InP substrate, however, the invention is similarly applicable to the cases of using a GaAs substrate, and a Si substrate, respectively. Furthermore, the invention is similarly applicable to not only the high-mesa ridge type laser, but also a transverse mode entrapment structure of laser oscillation such as a laser using the so-called embedding type structure, and so forth. Further, with the present embodiment, a wavelength band is a 1550 nm band; however, the present invention is not limited to a specific oscillation wavelength. The present invention is quite effective for practical use as it is applicable to a wavelength in a range of 850 to 1620 nm, often used in communications.

### Embodiment 2

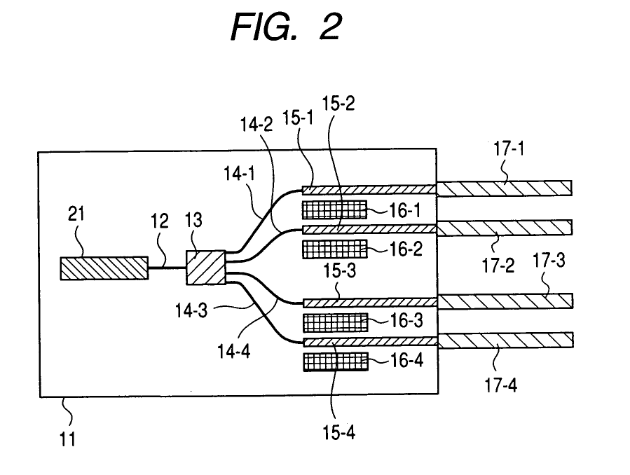

FIG. 2 shows a second embodiment of an optical transmitter according to the invention. The present embodiment is identical in structure to the first embodiment except that a semiconductor laser 21 is integrated on a semiconductor substrate 11. A method for fabricating the optical transmitter according to the present embodiment is the same as that for the first embodiment except that a gain layer of the semiconductor laser 21 is caused to undergo growth prior to formation of respective absorption layers of optical modulators 15-1, 15-2, 15-3, 15-4, and respective core layers of a laser beam input optical waveguide 12, an MMI (Multi Mode Interferometer) optical splitter 13, and optical splitter output waveguides 14-1, 14-2, 14-3, 14-4.

As the semiconductor laser is integrated, the optical transmitter can be reduced in size, so that the optical transmitter has a structure suitable in drawing optical signals in large capacity from a semiconductor LSI chip.

### Embodiment 3

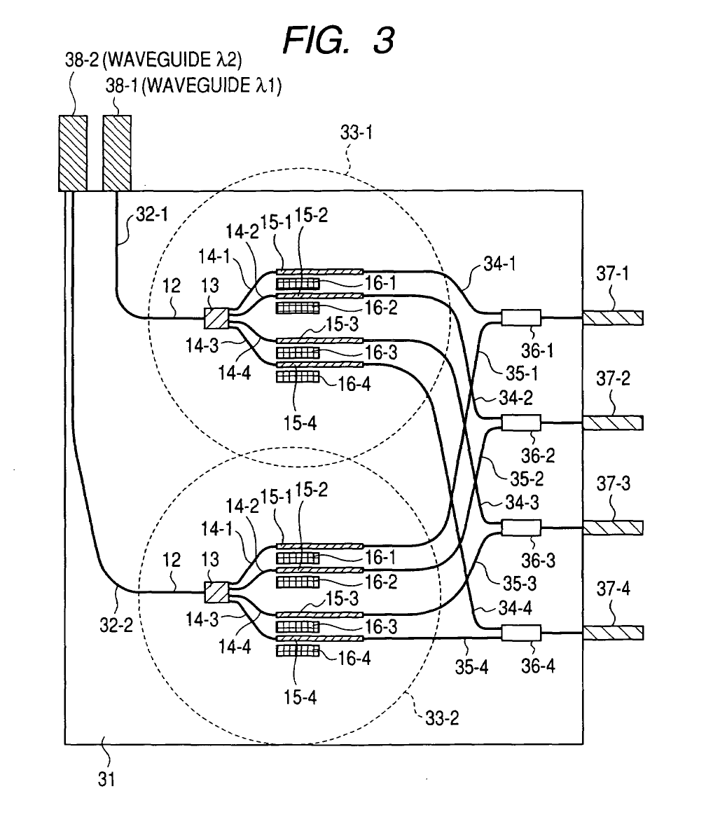

FIG. 3 shows a third embodiment of an optical transmitter according to the invention. Respective laser beams outputted from lasers 38-1, 38-2, differing in wavelength from each other, are caused to undergo modulation by a set of optical modulator 32-1, 32-2 to be then multiplexed before being outputted as wavelength multiplexing signals. As a result of wavelength multiplexing, the number of optical fibers 37-1, 37-2, 37-3, 37-4, into which the wavelength multiplexing signals are outputted, respectively, are reduced to four channels, corresponding to one half of those in the case where the wavelength multiplexing is not carried out, thereby facilitating adjustment for optical coupling between optical waveguides, and the optical fibers.

The present embodiment has the following makeup. A set of optical modulators 33-1, 33-2, each having a set made up of the optical modulator drive circuits 16-1, 16-2, 16-3, 16-4, the laser beam input optical waveguide 12, the MMI (Multi Mode Interferometer) optical splitter 13, the optical splitter output waveguides 14-1, 14-2, 14-3, 14-4, and the optical modulators 15-1, 15-2, 15-3, 15-4, according to the first embodiment, laser beam input optical waveguides 32-1, 32-2, output waveguides 34-1, 34-2, 34-3, 34-4 of the optical modulator 33-1, output waveguides 35-1, 35-2, 35-3, 35-4 of the optical modulator set 33-2, and MMI optical multiplexers 36-1, 36-2, 36-3, 36-4 are formed on an InP semiconductor substrate 31, and respective outputs from the MMI optical multiplexers 36-1, 36-2, 36-3, 36-4 are sent out from the optical fibers 37-1, 37-2, 37-3, 37-4. A method of fabricating the optical transmitter according to the present embodiment is the same as that for the first embodiment.

There has been described hereinabove an example where the number of laser beam wavelengths is two, however, the number of the lasers may be a plurality not less than two. Further, the lasers are formed separately from the semiconductor substrate 31, but are preferably formed on the semiconductor substrate 31. Further, for the optical multiplexers, use is made of the MMI type, however, use is more preferably made of an AWG (Arrayed Waveguide Grating) type having wavelength selectivity. Further, as a typical embodiment of the present invention, there has been described the high-mesa ridge type laser structure using the crystalline material on the InP substrate, however, the invention is similarly applicable to the cases of using the GaAs substrate, and the Si substrate, respectively. Furthermore, the invention is similarly applicable to not only the high-mesa ridge type laser, but also the transverse mode entrapment structure of laser oscillation such as the laser using the so-called embedding type structure, and so forth. Further, with the present embodiment, a wavelength band is a 1550 nm band, however, the present invention is not limited to a specific oscillation wavelength. The present invention is quite effective for practical use as it is applicable to a wavelength in the range of 850 to 1620 nm, often used in communications.

### Embodiment 4

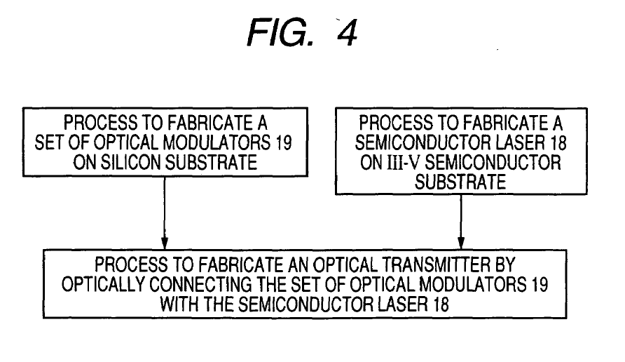

FIG. 4 shows a process flow for fabricating the optical transmitter according to the invention by way of example. The process flow comprises the step of fabricating optical modulator sets 19, the step of fabricating a semiconductor laser 18, and the step of completing the optical transmitter by optically coupling the optical modulator sets 19 with the semiconductor laser 18.

A semiconductor LSI as represented by the optical modulator drive circuits 16-1, 16-2, 16-3, 16-4 is normally formed on a silicon substrate. Further, it is well known that the laser beam input optical waveguide 12, the MMI (Multi Mode Interferometer) optical splitter 13, the optical splitter output waveguides 14-1, 14-2, 14-3, 14-4, and the optical modulators 15-1, 15-2, 15-3, 15-4 can also be formed on the silicon substrate.

On the other hand, it is extremely difficult to fabricate a laser on the silicon substrate, so that it is presumed to fabricate the laser on a substrate made of a semiconductor represented by InP and GaAs, belonging to the group III-V of the periodic table. Accordingly, it is considered practical to proceed with the step of fabricating optical modulator sets 19, and to proceed with the step of fabricating the semiconductor laser 18, independently from each other, thereby completing the optical transmitter by optically coupling the optical modulator sets 19 with the semiconductor laser 18.

1. An optical transmitter comprising:
a first optical waveguide optically coupled to a semiconductor laser for causing a laser beam outputted from the semiconductor laser to be propagated;
an optical splitter connected to the first optical waveguide, for splitting the laser beam into a plurality of laser beam components;
second waveguides connected to a plurality of optical output terminals of the optical splitter, respectively;
optical modulators optically coupled to the second waveguides, respectively; and
an electronic circuit for feeding a control signal to the respective optical modulators, respective constituents being provided on a semiconductor substrate,
wherein the laser beam components propagated through the respective optical modulators are modulated by the agency of the control signal.

2. An optical transmitter according to claim 1, wherein the semiconductor laser is formed on the semiconductor substrate.

3. An optical transmitter according to claim 1, wherein the optical splitter is a multi-mode interferometer.

4. An optical transmitter according to claim 1, wherein the optical splitter is of Y-branching type.

5. An optical transmitter comprising:
N (N is a integer≧2) units of optical waveguides optically coupled to N units of semiconductor lasers oscillating at respective wavelengths differing from each other, the respective optical waveguides for causing laser beams outputted from the respective semiconductor lasers to be propagated;
N units of optical splitters connected to the N units of optical waveguides, respectively, for splitting the respective laser beams into M (M is a integer) channels of laser beam components;
M unit of optical splitter output waveguides connected to respective output terminals of N units of the optical splitters;
optical modulators optically coupled to M unit of the optical splitter output waveguides, respectively; and
an electronic circuit for feeding a control signal to the respective optical modulators,
wherein M units of optical multiplexers, the respective optical multiplexers for multiplexing the laser beam component having a first wavelength, outputted from an i-th (1≦i≦M) optical modulator among M unit of the optical modulators, connected to one of N units of the optical splitters with the laser beam component having a wavelength differing from the first wavelength, outputted from the i-th optical modulator among M unit of the optical modulators, connected to another of N units of the optical splitters, are provided on a semiconductor substrate.

6. An optical transmitter according to claim 5, wherein the optical multiplexers each are an arrayed waveguide grating type multiplexer.

7. An optical transmitter according to claim 5, wherein at least one unit of N units of the semiconductor lasers is formed on the semiconductor substrate.

8. An optical transmitter according to claim 1, fabricated by a process comprising:
a first step for preparing a semiconductor substrate with the optical transmitter formed thereon;
a second step proceeding independently from the first step, for preparing a substrate of a semiconductor belonging to the group III-V of the periodic table, with a semiconductor laser or semiconductor lasers, formed thereon; and
a third step for assembling the semiconductor substrate with the substrate of the semiconductor belonging to the group.

9. An optical transmitter according to claim 5, fabricated by a process comprising:
a first step for preparing a semiconductor substrate with the optical transmitter formed thereon;
a second step proceeding independently from the first step, for preparing a substrate of a semiconductor belonging to the group III-V of the periodic table, with a semiconductor laser or semiconductor lasers, formed thereon; and
a third step for assembling the semiconductor substrate with the substrate of the semiconductor belonging to the group.
